(19) United States
(12) Patent Application Publication
(10) Pub. No.: US 2007/0028149 A1
(43) Pub. Date: Feb. 1, 2007

(54) System, method, and computer program product for reducing error causing conditions in an information handling system

(75) Inventors: Fabiano Baroni Desouza, Austin, TX (US); Jeffrey Conarko, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/194,292

(22) Filed: Aug. 1, 2005

(51) Int. Cl. G06F 11/00

(52) U.S. Cl. 714/48

(57) ABSTRACT

A system includes a first information handling system (“IHS”) for collecting information associated with conditions that cause errors in a second IHS. The first IHS is also for, in response to the information, forming a list of error-causing conditions. Moreover, the first IHS is for outputting the list to the second IHS, whereby in response to the list, the second IHS determines whether an error causing condition included in the list is present, and in response to determining that the error-causing condition is present, modifying the error causing condition.

### BACKGROUND

The description herein relates generally to information handling systems (“IHSs”) and more particularly to a system, method, and computer program product for reducing error causing conditions in an IHS.

As the value and use of information continues to increase, individuals and businesses seek additional ways to process and store information. One option is an information handling system (“IHS”). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

While operating, an IHS may be subject to various problems. For example, an IHS may fail (e.g., “crash”) or otherwise cause errors. More specifically, such failure or errors are caused by various error causing conditions present in the IHS. Such error causing conditions are associated with, for example, device drivers, the IHS' basic input/output system (“BIOS”), and software applications.

Failures or errors of an IHS potentially reduces productivity (e.g., productivity of the IHS' user). For example, such failures or errors may cause loss of time and work. Failures or errors of an IHS also causes problems for a manufacturer/seller of IHSs because the manufacturer/seller is often responsible for resolving such failures or errors.

What is needed is a method, a system, and a computer program product for reducing error causing conditions, without the disadvantages discussed above.

### SUMMARY

Accordingly, a method, a system and a computer program product is provided. The method includes, collecting information associated with conditions that cause errors in a second IHS. The method also includes, in response to the information, forming a list of error-causing conditions. Moreover, the method includes, outputting the list to the second IHS, whereby, in response to the list, the second IHS determines whether an error causing condition included in the list is present, and in response to determining that the error-causing condition is present, modifying the error causing condition.

### BRIEF DESCRIPTION OF THE DRAWINGS

FIG. 1 is a block diagram of a system according to an illustrative embodiment.

FIG. 2. is a block diagram of an information handling system (“IHS”) that is representative of the IHSs of the system of FIG. 1.

FIG. 3 is a block diagram of a storage device, that is representative of a storage device of a client IHS of the system of FIG. 1

FIG. 4 is a conceptual illustration of a process executed by a server IHS of the system of FIG. 1.

FIG. 5 is a conceptual illustration of processes executed by a client IHS of the system of FIG. 1.

FIG. 6 is a flow chart of an operation performed by a client IHS of the system of FIG. 1.

### DETAILED DESCRIPTION

For purposes of this disclosure, an information handling system (“IHS”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (“CPU”) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

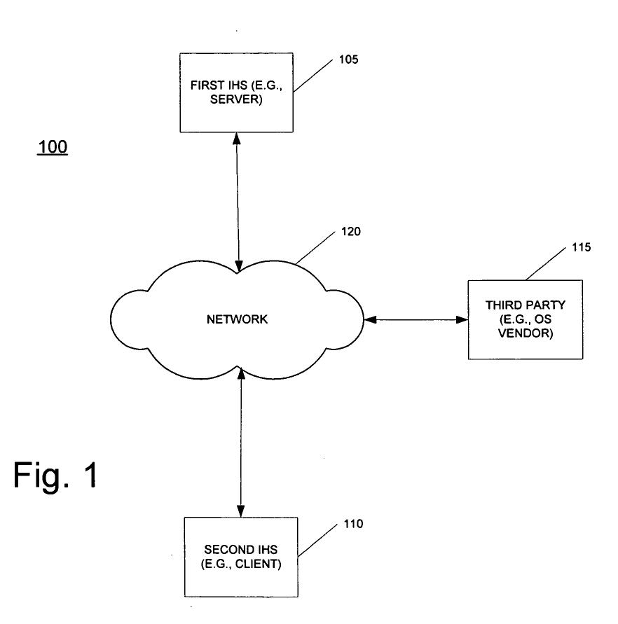

FIG. 1 is a block diagram of a system, indicated generally at 100, according to the illustrative embodiment. The system 100 includes a first IHS (e.g., a server) 105, a second IHS (e.g., a client) 110, and a third party IHS (e.g., an IHS of a third party such as an operating system (“OS”) vendor) 115. The system 100 also includes a computer network 120, such as a Transport Control Protocol/Internet Protocol (“TCP/IP”) network (e.g., the Internet or an intranet).

Each of the first IHS 105, the second IHS 110, and the third party IHS 115 includes a respective network interface for communicating with the network 120 (e.g., outputting information to and, and receiving information from, the network 120), such as by transferring information (e.g., instructions, data, signals) between such second party and the network 120. Accordingly, through the network 120, the first IHS 105 communicates with the second IHS 110 and the third party IHS 115, and vice versa.

For clarity, FIG. 1 depicts only one second IHS 105 although the system 100 may include additional IHSs (e.g., third and fourth IHSs) which are substantially identical to one another. Likewise, for clarity, FIG. 1 depicts only one third party IHS 115 although the system 100 may include additional third party IHSs, which are substantially identical to one another.

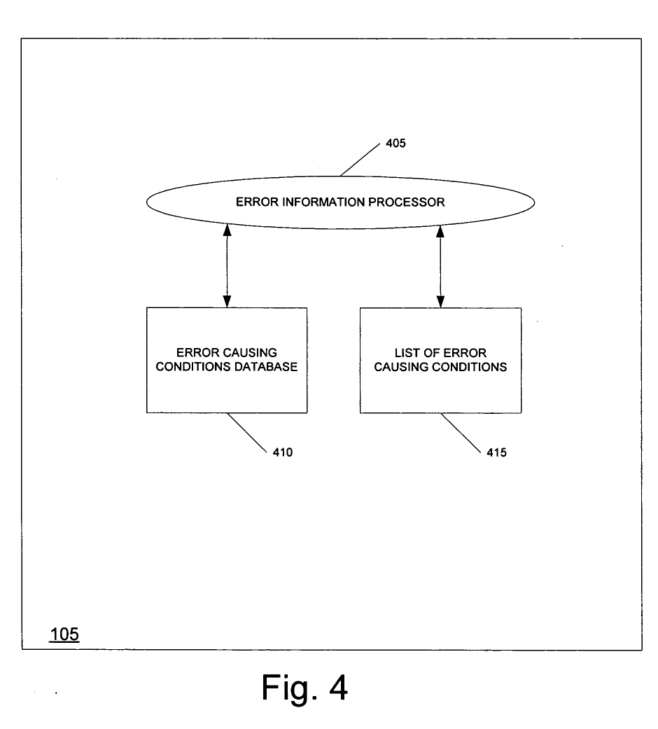

Each of the first IHS 105, the second IHS 110, and the third party IHS 115 is for executing processes and performing operations (e.g., processing and communicating information) in response thereto, as discussed further below in connection with, for example, FIGS. 4, 5, and 6. Each such IHS is formed by various electronic circuitry components. Moreover, as shown in FIG. 1, all such IHSs are coupled to one another. Accordingly, the first IHS 105, the second IHS 110, and the third party IHS 115 operate within the network 120.

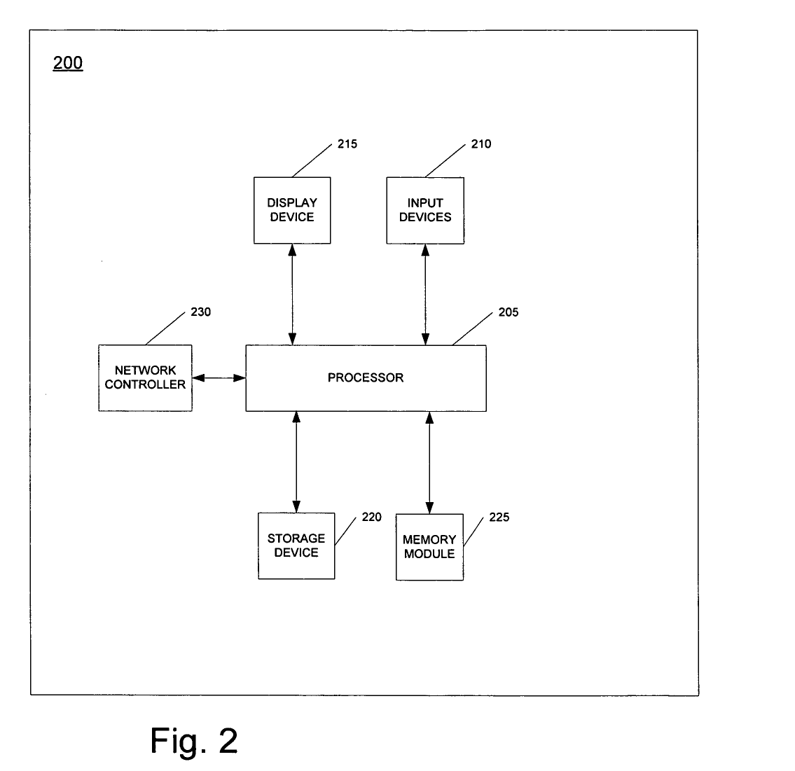

FIG. 2 is block diagram of an IHS, indicated generally at 200, that is representative of the IHSs of the FIG. 1. The IHS 200 includes a processor 205 (e.g., an Intel Pentium series processor) for executing and otherwise processing instructions, input devices 210 for receiving information from a human user, a display device 215 (e.g., a cathode ray tube (“CRT”) device, a projector, a liquid crystal display (“LCD”) device, or a plasma display device) for displaying information to the user, a storage device 220 (e.g., a non-volatile storage device such as a hard disk drive or other computer readable medium or apparatus) for storing information, a memory module 225 (e.g., random access memory (“RAM”) module and read only memory (“ROM”) modules), also for storing information, and a network controller 230 for communicating between the IHS 100 and a network. Examples of the memory module 225 include single in-line memory modules (“SIMMS”) and double in-line memory modules (“DIMMS”) such as fully-buffered DIMMs (“FB-DIMMs”). The memory device 225 is an example of the storage device 220.

Each of the input devices 210, the display device 215, the storage device 220, the memory device 225, and the network controller 230 is coupled to the processor 205, and to one another. Also, in one example, the IHS 100 includes various other electronic circuitry for performing other operations of the IHS 100, such as a print device (e.g., a ink-jet printer or a laser printer) for printing visual images on paper.

The input devices.210 include, for example, a conventional keyboard and a pointing device (e.g., a “mouse”, a roller ball, or a light pen). A user operates the keyboard to input alphanumeric text information to the processor 205, and the processor receives such information from the keyboard. A user also operates the pointing device to input cursor-control information to the processor 205, and the processor 205 receives such cursor-control information from the pointing device.

In FIG. 1, the first IHS 105 is associated with, for example, a manufacturer and/or a seller of IHSs, such as the second IHS 110. As discussed above, while operating, an IHS may be subject to various errors. Accordingly, in the system 100, one or more of the first IHS 105, the second IHS 110, the third party IHS 115 executes processes for reducing error causing conditions in the second IHS 110. For clarity, the following discussions reference the first IHS 105 as a server IHS 105 and the second IHS 110 as a client IHS.

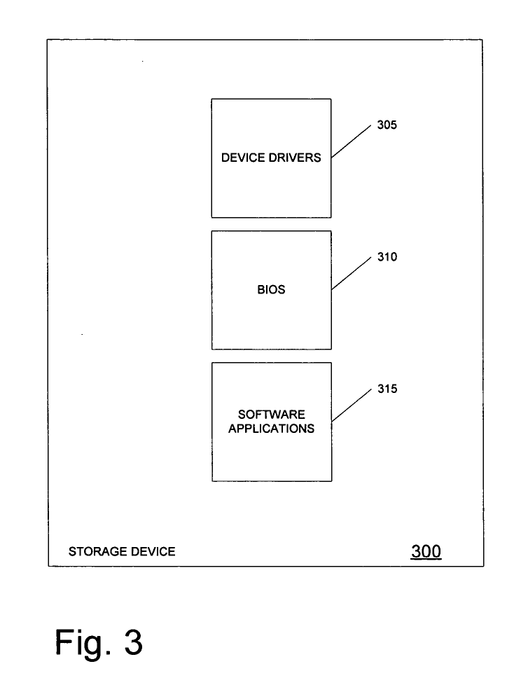

FIG. 3 is a block diagram of a storage device, indicated generally at 300, that is representative of the storage device of the client IHS 110. The storage device 300 includes device drivers 305, BIOS 310, and software applications 315. In a typical example, the BIOS 310 is stored in another type of storage device (e.g., a electronically erasable programmable read only memory (“EEPROM”).

The device drivers 305, the BIOS 310, the software applications 315 are associated with various error causing conditions. In one example, one or more of the device drivers 305 may be incompatible with one or more devices of the IHS because, the device driver is out-dated. Such device driver may cause errors on the IHS. Similarly, one or more incompatible software applications included among the software applications 315 may cause errors on the IHS. Likewise, if it is out-dated, the BIOS 310 may cause errors on the IHS.

FIG. 4 is a conceptual illustration of a process executed by the server IHS 105. The server IHS 105 executes an error information processor 405. The server IHS 105 executes the processor 405 in association with an error causing conditions database 410 and a list of error causing conditions 415. More particularly, by executing the processor 405, the server IHS 105 collects information associated with error causing conditions and stores such information in the database 410. In the illustrative embodiment, the server IHS 105 collects such information by receiving the information from the third party IHS 115. In one example, the third party is Microsoft. The server IHS 105 periodically receives from Microsoft, Online Crash Analysis (“OCA”) data. The server IHS 105 parses through the OCA data and stores the error causing conditions associated with the client IHS 110 in the database 410. For example, an error causing condition that is associated with the client IHS 110 includes a device driver for a device that is included in the client IHS 110. Also, some error causing conditions are specifically associated with a manufacturer (e.g., Dell).

In response to the information stored in the database 410, the server IHS 105 forms the list of error causing conditions 415. In one example, the list 415 is an XML based file and includes a predetermined number (e.g., “top 50”) of error causing conditions. For an error causing condition associate with a driver, the list 415 includes information including driver name, driver version, plug and play.(“PNP”) identification, manufacturer, and device class.

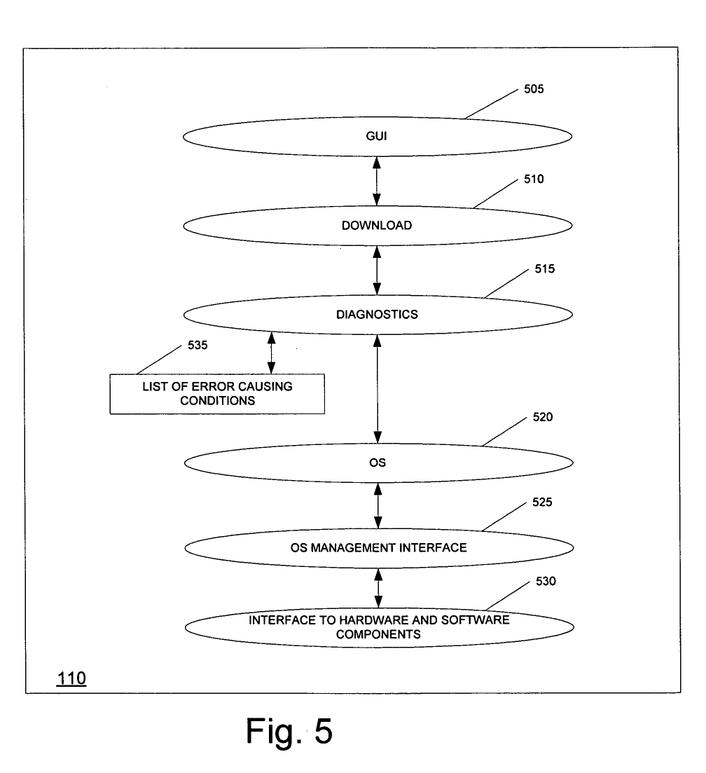

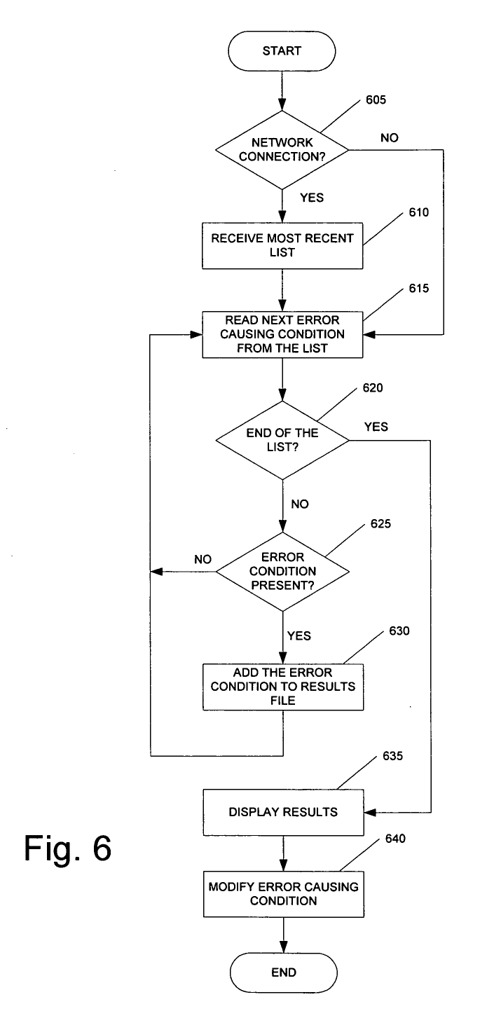

By executing the processor 405, the server IHS 105 outputs the list 415 to the client IHS 110 as discussed in more detail below (in connection with FIGS. 5 and 6). In one example, the server IHS 105 outputs the list 415 in response to a request received from the client IHS 110.

FIG. 5 is conceptual illustration of various processes executed by the client IHS 110 of FIG. 1. The client IHS 110 executes a graphical user interface (“GUI”) process 505, a download process 510, and a diagnostics process 515. The client IHS 110 executes the process 515 in association with a list of error causing conditions 535. The client IHS 110 receives the list 535 from the server IHS 105, and accordingly, the list 535 is substantially identical to the list 415.

The client IHS 110 also executes an OS (e.g., a Microsoft Windows OS) 520, an OS management interface 525 such as the Windows Management Instrumentation (“WMI”) interface, and an interface to hardware and software components 530. By executing the process 110, the client IHS 110 is capable of receiving a user command to initiate the process 510 and process 515. In an alternative example, the client IHS 110 initiates the processes 510 and 515 without a user command (e.g., in response to a schedule). By executing the process 510, the client IHS 110 receives the list 535 from the server IHS 105. Moreover, by executing the process 515, the client IHS 110 performs operations to detect and reduce error causing conditions as discussed in more detail below in connection with FIG. 6.

Accordingly, FIG. 6 is a flow chart of an operation performed by the client IHS 110 to detect and reduce error causing conditions. The operation begins at a step 605, where the client IHS 110 determines whether it is connected to a network (e.g., the network 120). If the client IHS 110 determines that it is not connected to a network, the operation continues to a step 615. Otherwise the operation continues to a step 610.

At the step 610, the client IHS 110 receives (e.g., downloads) a most recent list of error causing conditions (e.g., the list 535). After the step 610, the operation continues to the step 615.

At the step 615, the client IHS 110 reads the next error causing condition from the list that is received at the step 610 or if the client IHS 110 determined negatively at the step 605, a list that previously existed on the client IHS 110. After the step 615, the operation continues to a step 620.

At the step 620, the client IHS 110 determines whether it has reached the end of the list (e.g., by determining whether it has reached the end of file (“EOF”)). If so, the operation continues to a step 635. Otherwise, the operation continues to a step 625.

At the step 625, the client IHS 110 determines whether the error causing condition that was read at the step 615 is present in the client IHS 110. In one example, the client IHS 110 makes such determination by forming a WMI query, which is transmitted to the OS 520. If the client IHS 110 determines that the error causing condition is present, the operation continues to a step 630. Otherwise, the operation returns to the step 615.

At the step 630, the client IHS 110 adds the error causing condition that was determined to be present to a results list (e.g., in a list included in a file). After the step 630, the operation returns to the step 615.

At the step 635, the client IHS 110 displays the results (i.e., the results file of the step 630), including the error causing conditions included in the list of error causing conditions that were determined to be present, to its user. After the step 635, the operation continues to a step 640.

At the step 640, the client IHS 110 modifies (e.g., by updating a driver, a software application and/or the BIOS) the error causing conditions. In one example, the client IHS 110 modifies the error causing conditions in response to a user command. However, in another example, the client IHS 110 modifies the error causing conditions without such command from the user. After the step 640, the operation ends.

Referring again to FIG. 2, the storage device 220 is a computer-readable medium. For clarity, the following discussion references the storage device 220 as a computer readable medium 220. The computer-readable medium 220 and the processor 205 are structurally and functionally interrelated with one another as described further below. Each IHS of the illustrative embodiment is structurally and functionally interrelated with a respective computer-readable medium, similar to the manner in which the processor 205 is structurally and functionally interrelated with the computer-readable medium 220. In that regard, the computer-readable medium 220 is a representative one of such computer-readable media, including for example but not limited to a hard disk drive.

The computer-readable medium 220 stores (e.g., encodes, or records, or embodies) functional descriptive material (e.g., including but not limited to software (also referred to as computer programs or applications) and data structures). Such functional descriptive material imparts functionality when encoded on the computer-readable medium 220. Also, such functional descriptive material is structurally and functionally interrelated to the computer-readable medium 220.

Within such functional descriptive material, data structures define structural and functional interrelationships between such data structures and the computer-readable medium 220 (and other aspects of the processor 205, the IHS 200 and the system 100). Such interrelationships permit the data structures' functionality to be realized. Also, within such functional descriptive material, computer programs define structural and functional interrelationships between such computer programs and the computer-readable medium 220 (and other aspects of the processor 205, the IHS 200 and the system 100). Such interrelationships permit the computer programs' functionality to be realized.

For example, the processor 205 reads (e.g., accesses or copies) such functional descriptive material from the computer-readable medium 220 into the memory device of the IHS 200, and the IHS 200 (more particularly, the processor 205) performs its operations (as described elsewhere herein) in response to such material which is stored in the memory device of the IHS 200. More particularly, the processor 205 performs the operation of processing a computer application (that is stored, encoded, recorded or embodied on a computer-readable medium) for causing the processor 205 to perform additional operations (as described elsewhere herein). Accordingly, such functional descriptive material exhibits a functional interrelationship with the way in which processor 205 executes its processes and performs its operations.

Further, the computer-readable medium 220 is an apparatus from which the computer application is accessible by the processor 205, and the computer application is processable by the processor 205 for causing the processor 205 to perform such additional operations. In addition to reading such functional descriptive material from the computer-readable medium 220, the processor 205is capable of reading such functional descriptive material from (or through) the network 120 which is also a computer-readable medium (or apparatus). Moreover, the memory device 225 of the IHS 200 is itself a computer-readable medium (or apparatus).

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A method performed by a first information handling system (“IHS”), the method comprising:
collecting information associated with conditions that cause errors in a second IHS;
in response to the information, forming a list of error-causing conditions; and
outputting the list to the second IHS, whereby in response to the list, the second IHS determines whether an error causing condition included in the list is present, and in response to determining that the error-causing condition is present, modifying the error causing condition.

2. The method of claim 1, wherein the information error-causing conditions is received from a third party.

3. The method of claim 1, wherein the error causing-condition included in the list is associated with at least one of the following: device driver, basic input output system (“BIOS”), and a software application.

4. The method of claim 1, wherein an error caused by the error causing condition includes at least one of the following: system crash, device failure, software failure, loss of data, and system slow-down.

5. The method of claim 1, wherein the second IHS determines whether the error causing condition included in the list is present by querying an operating system (“OS”).

6. The method of claim 1, wherein the second IHS modifies the error-causing condition by performing at least one of the following operations: updating a device driver, updating a software application, and updating a BIOS.

7. A system comprising:
a first information handling system (“IHS”) for:
collecting information associated with conditions that cause errors in a second IHS;
in response to the information, forming a list of error-causing conditions;
and
outputting the list to the second IHS, whereby in response to the list, the second IHS determines whether an error causing condition included in the list is present, and in response to determining that the error-causing condition is present, modifying the error causing condition.

8. The system of claim 7, wherein the information associated with error-causing conditions is received from a third party.

9. The system of claim 8, wherein the information associated with error-causing conditions is Microsoft Online Crash Analysis (“OCA”) data.

10. The system of claim 7, wherein the error causing-condition included in the list is associated with at least one of the following: device driver, basic input output system (“BIOS”), and a software application.

11. The system of claim 7, wherein an error caused by the error causing condition includes at least one of the following: system crash, device failure, software failure, loss of data, and system slow-down.

12. The system of claim 7, wherein the second IHS determines whether the error causing condition included in the list is present by querying an operating system (“OS”).

13. The system of claim 7, wherein the second IHS modifies the error-causing condition by performing at least one of the following operations: updating a device driver, updating a software application, and updating a BIOS.

14. A computer program product comprising:
a computer program processable by a first information handling system (“IHS”) for causing the first IHS to:
collect information associated with conditions that cause errors in a second IHS;
in response to the information, form a list of error-causing conditions; and
output the list to the second IHS, whereby in response to the list, the second IHS determines whether an error causing condition included in the list is present, and in response to determining that the error-causing condition is present, modifying the error causing condition; and
an apparatus from which the computer program is accessible from a computer readable medium.

15. The computer program product of claim 14, wherein the information associated with error-causing conditions is received from a third party.

16. The computer program product of claim 15, wherein the information associated with error-causing conditions is Microsoft Online Crash Analysis (“OCA”) data.

17. The computer program product of claim 14, wherein the error causing-condition included in the list is associated with at least one of the following: device driver, basic input output system (“BIOS”), and a software application.

18. The computer program product of claim 14, wherein an error caused by the error causing condition includes at least one of the following: system crash, device failure, software failure, loss of data, and system slow-down.

19. The computer program product of claim 14, wherein the second IHS determines whether the error causing condition included in the list is present by querying an operating system (“OS”).

20. The computer program product of claim 14, wherein the second IHS modifies the error-causing condition by performing at least one of the following operations: updating a device driver, updating a software application, and updating a BIOS.
